(19) United States
(12) Patent Application Publication
(10) Pub. No.: US 2007/0253434 A1
(43) Pub. Date: Nov. 1, 2007

(54) Performing A Graceful Restart Operation For Wimax Network Protocols

(76) Inventors: Anand K. Oswal, Sunnyvale, CA (US); Michael L. Shannon, San Jose, CA (US); Jayaraman R. Iyer, Sunnyvale, CA (US)

Correspondence Address: BAKER BOTTS L.L.P., 2001 ROSS AVENUE, SUITE 600, DALLAS, TX, 75201-2980, US

(21) Appl. No.: 11/380,950

(22) Filed: May 1, 2006

(51) Int. Cl. H04L 12/56

(52) U.S. Cl. 370/401

(57) ABSTRACT

Facilitating a graceful restart operation includes initiating the graceful restart operation at a gateway of an access service network. A graceful restart request is sent to a helper device. The graceful restart request requests that the helper device recognize the gateway as adjacent during a specified grace period. If the helper device supports the graceful restart operation, information is received from the helper device in response to the graceful restart request. The graceful restart operation is terminated.

### TECHNICAL FIELD

This invention relates generally to the field of communications and more specifically to performing a graceful restart operation for WiMax network protocols.

### BACKGROUND

Communications systems use control and forwarding functions to provide communications sessions. Control functions manage the control and signaling of a communication session, and forwarding functions manage the data flow of the communication session. In certain communication systems, the control functions may be separated from the forwarding functions. In these systems, known techniques may provide a graceful restart for the control functions, which allow the forwarding functions to continue to operate. These known techniques, however, are not effective in certain situations. It is generally desirable to have effective techniques for providing a graceful restart.

### SUMMARY OF THE DISCLOSURE

In accordance with the present invention, disadvantages and problems associated with previous techniques for performing a graceful restart operation may be reduced or eliminated.

According to one embodiment of the present invention, facilitating a graceful restart operation includes initiating the graceful restart operation at a gateway of an access service network. A graceful restart request is sent to a helper device. The graceful restart request requests that the helper device recognize the gateway as adjacent during a specified grace period. If the helper device supports the graceful restart operation, information is received from the helper device in response to the graceful restart request. The graceful restart operation is terminated.

Certain embodiments of the invention may provide one or more technical advantages. A technical advantage of one embodiment may be that a gateway may be operable to perform a graceful restart for control functions, while allowing forwarding functions to forward data. The gateway may initiate a graceful restart by sending a graceful restart request. Another technical advantage of one embodiment may be that the graceful restart may be performed for an R4 or an R6 interface. Another technical advantage of one embodiment may be that a graceful restart may be terminated and normal operation may be resumed if network topology changes are detected.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a network system 10 for which a graceful restart operation may be performed;

FIG. 2 is a diagram illustrating one embodiment of a graceful restart request that may be used to request a graceful restart; and

FIG. 3 is a call flow diagram illustrating one embodiment of a method for performing a graceful restart operation for R6/R4 reference points that may be used with system 10 of FIG. 1.

### DETAILED DESCRIPTION OF THE DRAWINGS

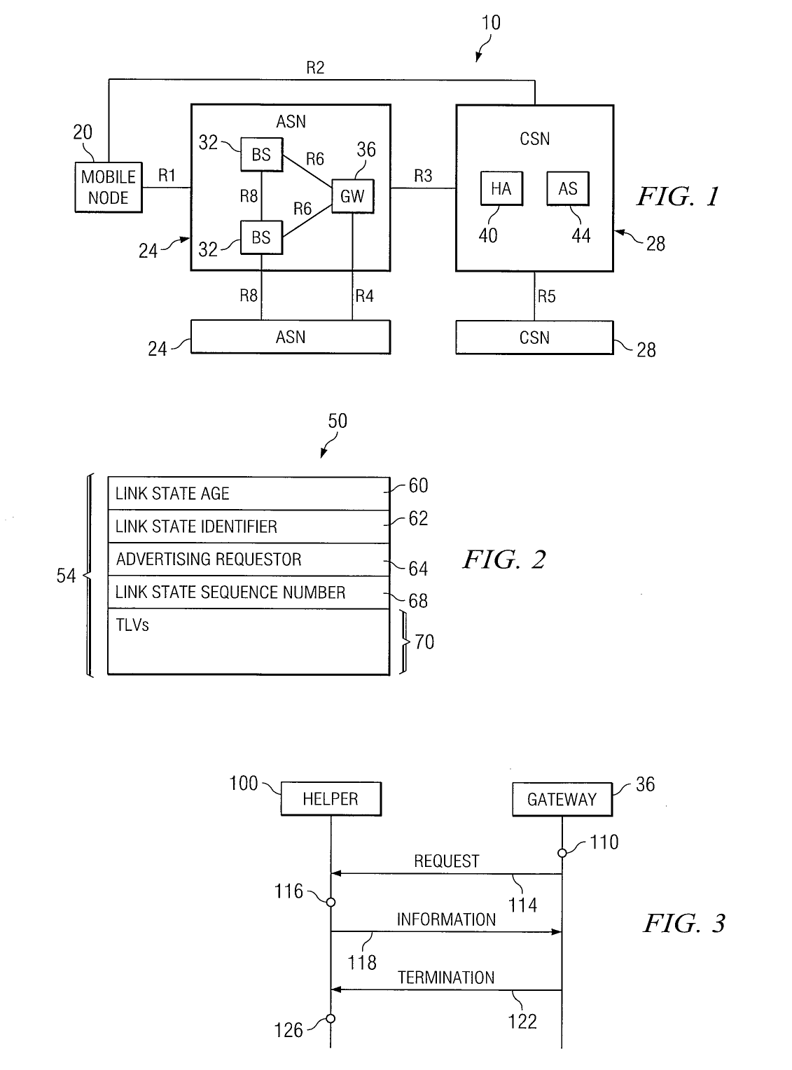

Embodiments of the present invention and its advantages are best understood by referring to FIGS. 1 through 3 of the drawings, like numerals being used for like and corresponding parts of the various drawings.

FIG. 1 is a block diagram illustrating one embodiment of a network system 10 for which a graceful restart operation may be performed. A gateway of system 10 may be operable to perform a graceful restart for control functions, while allowing forwarding functions to forward data. The gateway may initiate a graceful restart by sending a graceful restart request over an R6/R4 interface. If network topology changes are detected, the graceful restart may be terminated and normal operation may be resumed.

According to the illustrated embodiment, system 10 operates to provide services such as communication sessions to endpoints such as mobile node 20. A communication session may refer to an active communication between endpoints, measured from endpoint to endpoint. Information is communicated during a communication session. Information may refer to voice, data, text, audio, video, multimedia, control, signaling, other information, or any combination of the preceding. System 10 may communicate information in packets. A packet may comprise a bundle of data organized in a specific way for transmission, and a frame may comprise the payload of one or more packets organized in a specific way for transmission. A packet-based communication protocol such as Internet Protocol (IP) may be used to communicate the packets.

System 10 may utilize communication protocols and technologies to provide the communication sessions. Example communication protocols and technologies include those set by the Institute of Electrical and Electronics Engineers, Inc. (IEEE) 802.xx standards such as the 802.11 and 802.16 standards (for example, the 802.16e standards), the International Telecommunications Union (ITU-T) standards, the European Telecommunications Standards Institute (ETSI) standards, the Internet Engineering Task Force (IETF) standards, or other standards.

System 10 includes components such as devices. In general, a device may include any suitable arrangement of components operable to perform the operations of the device, and may comprise logic, an interface, memory, other component, or any suitable combination of the preceding.

“Logic” may refer to hardware, software, other logic, or any suitable combination of the preceding that may be used to provide information or instructions. Certain logic may manage the operation of a device, and may comprise, for example, a processor. “Processor” may refer to any suitable device operable to execute instructions and manipulate data to perform operations.

“Interface” may refer to logic of a device operable to receive input for the device, send output from the device, perform suitable processing of the input or output or both, or any combination of the preceding, and may comprise one or more ports, conversion software, or both. “Memory” may refer to logic operable to store and facilitate retrieval of information, and may comprise Random Access Memory (RAM), Read Only Memory (ROM), a magnetic drive, a disk drive, a Compact Disk (CD) drive, a Digital Video Disk (DVD) drive, removable media storage, any other suitable data storage medium, or a combination of any of the preceding.

According to the illustrated embodiment, system 10 includes one or more mobile nodes 20, one or more access service networks (ASNs) 24, and one or more connectivity service networks (CSNs) 28. An access service network 24 includes one or more base stations 32 and a gateway 36, and connectivity service network 28 includes a home agent 40 and an authentication, authorization, and/or accounting (AAA) server 44.

According to the illustrated embodiment, mobile node 20 represents any suitable device operable to communicate with a communication system. Mobile node 20 may comprise, for example, a personal digital assistant, a computer such as a laptop, a cellular telephone, a mobile handset, or any other device operable to communicate with system 10.

Access service network 24 represents a communication network that provides mobile node 20 access to a wired network. In general, a communication network allows devices to communicate with other devices. A communication network may comprise all or a portion of a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

According to one embodiment, access service network 24 may comprise a WiMax access service network. Access service network 24 may be provided by a network access provider. A network access provider may refer to an entity that provides WiMax radio access infrastructure to one or more WiMax network service providers.

Access service network 24 includes one or more base stations 32 and gateway 36. A base station 32 represents any suitable device system that provides wireless services to mobile node 20 present in, or visiting, a cell of base station 32. For example, base station 24 may represent an access location that couples a wireless network, such as a wireless radio network, to a wired network, such as a wired area network. A cell may refer to a geographic unit serviced by a base station 32.

A base station 32 may comprise suitable devices operable to provide wireless services to mobile nodes 20 present in a cell. According to one embodiment, base station 32 includes a base transceiver station and a base station controller. The base transceiver station communicates signals to and from mobile node 20 through a wireless link that is typically a radio frequency link. The base station controller manages the operation of the base transceiver station.

Gateway 36 represents a device operable to manage communication among base stations 32, and may comprise a WiMax ASN gateway. According to one embodiment, gateway 36 may be operable to perform a graceful restart operation for control functions, while allowing forwarding functions to forward data. An example graceful restart operation is described in more detail with reference to FIG. 3.

Gateway 28 may provide other suitable operations. For example, gateway 28 may convert communications between different communication protocols. For example, gateway 28 may convert communications from a protocol used by network 24 to a different protocol, or vice-versa.

Connectivity service network 28 represents a communication network that provides mobility management for mobile node 20. Connectivity service network 28 may also provide other operations, for example, authorization operations, host configuration management operations, other operation, or any combination of the preceding. Connectivity service network 28 may be provided by a network service provider. A network service provider may refer to an entity that provides IP connectivity and WiMAX services to subscribers.

Connectivity service network 28 includes home agent 40 and AAA server 44. A home agent 40 of a mobile node 20 may represent an agent that allocates the address of mobile node 20 and forwards packets to mobile node 20. AAA server 44 may represent any suitable device operable to provide AAA-related services. AAA-related services may include services for authentication, authorization, accounting, or any suitable combination of the preceding. Authentication may refer to validating the identity of mobile node 20. Authorization may refer to authorizing a level of service for mobile node 20. Accounting may refer to tracking the usage of resources. As an example, an authorization server may provide one, two, or three of the listed services.

System 10 includes reference points R1 through R8. A reference point represents an interface between entities, which in turn represent a collection of control protocols and bearer endpoints. According to one embodiment, a reference point comprises a WiMax reference point.

Reference point R1 represents the interface between mobile node 20 and access service network 24. Reference point R1 may be configured according to air interface specifications, such as the physical and media access control (MAC) specifications of IEEE P802.16d and e. Reference point R1 may include protocols for the management plane.

Reference point R2 represents the interface between mobile node 20 and connectivity service network 28. Reference point R2 may represent a logical interface and need not reflect a direct protocol interface.

Reference point R3 represents the interface between access service network 24 and connectivity service network 28. Reference point R3 may be used to support the functions provided by connectivity service network 28, for example, authorization service, policy enforcement, and mobility management functions.

Reference point R3 may utilize bearer plane technologies, for example, tunneling, to transfer data between access service network 24 and connectivity service network 28.

Reference point R4 represents the interface between access service networks 24 or gateways 28. Reference point R4 may utilize control and bearer plane protocols that originate or terminate within an access service network 24. The protocols may coordinate mobile node mobility between access service networks 24.

Reference point R5 represents the interface between connectivity service networks 28. Reference point R5 may utilize control and bearer plane protocols for Internet working between connectivity service networks 28.

Reference point R6 represents the interface between base station 32 and gateway 36. Reference point R6 may utilize control and bearer plane protocols for communication between base station 32 and gateway 36. The control plane may include protocols for IP tunnel management in accordance with mobile node mobility. The bearer plane may comprise and intra-ASN data path or inter-ASN tunnels between base station 32 and gateway 36. Reference point R6 may serve as a conduit for the exchange of media access control states between neighboring base stations 32.

Reference point R8 represents the interface between base stations 32, which may be of the same or different access service networks 24. Reference point R8 includes control plane message flows and bearer plane data flows between base stations 32. The control plane may utilize any suitable inter-base station protocols, for example, a protocol defined by IEEE 802.16 and any suitable protocol that allows for data transfer between base stations. The bearer plane may include protocols that allow for data transfer between base stations 32 involved in a handover of a mobile node 20.

Modifications, additions, or omissions may be made to system 10 without departing from the scope of the invention. The components of system 10 may be integrated or separated according to particular needs. Moreover, the operations of system 10 may be performed by more, fewer, or other modules. Additionally, operations of system 10 may be performed using any suitable logic. As used in this document, “each” refers to each member of a set or each member of a subset of a set.

FIG. 2 is a diagram illustrating one embodiment of a graceful restart request that may be used to request a graceful restart. According to the embodiment, the graceful restart request comprises a grace link state advertisement (LSA) 50 that a requester may send to neighbors to request aid in performing a graceful restart. Grace link state advertisement 50 requests that the neighbors continue to recognize the requester as fully adjacent during a specified grace period. The neighbors may recognize the requester as fully adjacent by maintaining the state of the requester as fully adjacent, by advertising the requester as fully adjacent, or both.

According to the illustrated embodiment, grace link state advertisement 50 includes fields 54. Fields 54 may include a link state age field 60, a link state identifier (ID) field 62, an advertising requester field 64, a link state sequence number field 68, and one or more type-length-value (TLV) fields 70.

Link state age field 60 indicates the age of advertisement 50. Link state identifier field 62 indicates the interface identifier of the interface from which advertisement 50 originated. Advertising requester field 64 indicates the requester sending advertisement 50. Link state sequence number 68 is used to detect old or duplicate advertisements 50.

Type-length-value fields 70 may specify parameters of the graceful restart. As an example, a type-length-value field 70 may indicate a grace period. A grace period may refer to the duration during which the neighbors should recognize the requester as fully adjacent, regardless of the state of the database synchronization between the requester and its neighbors. A type-length-value field 70 may also provide a graceful restart reason. A graceful restart reason may indicate the reason for a restart. Example reasons may include a software restart, a software reload/upgrade, a switch to redundant control processor, unknown, or other suitable reason.

Modifications, additions, or omissions may be made to the graceful restart request without departing from the scope of the invention. The graceful restart request may include more, fewer, or other fields that may have other suitable values. Additionally, the fields may be arranged in any suitable configuration without departing from the scope of the invention.

FIG. 3 is a call flow diagram illustrating one embodiment of a method for performing a graceful restart operation for R6/R4 reference points that may be used with system 10 of FIG. 1. According to the embodiment, the graceful restart operation may be performed between gateway 36 of access service network 24 and a helper 100. If the graceful restart operation is performed for an R6 reference point, helper 100 may be a base station 24 of access service network 24. If the graceful restart operation is performed for an R4 reference point, helper 100 may be another gateway, which may be of the same or different access service network 24.

The method begins at step 110, where gateway 36 of access service network 24 initiates a graceful restart. Gateway 36 creates registration with base stations 32 and other gateways 36. Gateway 36 sends graceful restart requests to helper 100 at step 114. The graceful restart request requests aid in performing a graceful restart, and may comprise a grace link state advertisement.

A helper 100 ceases new activity control functions upon receipt of the graceful restart request at step 116. As an example, helper 100 may stop initiating registrations, session/user updates, or radio condition updates. Helper 100 may continue to forward traffic for existing sessions.

If helper 100 supports the graceful restart operation, helper 100 downloads graceful restart information to gateway 36 at step 118. Graceful restart information may comprise information that gateway 36 may use to perform the graceful restart operation, for example, the information may allow gateway 36 to continue to forward traffic for existing sessions. Graceful restart information may include, for example, information about existing sessions, such as user information, session information, radio dependent and independent information, other information, or any combination of the preceding. If helper 100 does not support graceful restart, helper 100 may ignore the request.

The graceful restart operation may be terminated at step 122. According to one embodiment, gateway 36 may send an acknowledgement and termination message to terminate the graceful restart operation. The termination message may comprise a graceful restart request with a time period of zero. Helper 100 terminates the graceful restart upon receipt of the termination message. According to another embodiment, the graceful restart operation may be terminated upon expiration of a grace period timer. After the graceful restart operation terminates, the method terminates.

Modifications, additions, or omissions may be made to the method without departing from the scope of the invention. The method may include more, fewer, or other steps. Additionally, steps may be performed in any suitable order without departing from the scope of the invention.

Certain embodiments of the invention may provide one or more technical advantages. A technical advantage of one embodiment may be that a gateway may be operable to perform a graceful restart for control functions, while allowing forwarding functions to forward data. The gateway may initiate a graceful restart by sending a graceful restart request over an R6/R4 interface. Another technical advantage of one embodiment may be that a graceful restart may be terminated and normal operation may be resumed if network topology changes are detected.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A method for facilitating a graceful restart operation, comprising:
initiating a graceful restart operation at a gateway of an access service network;
sending a graceful restart request to a helper device, the graceful restart request requesting that the helper device recognize the gateway as adjacent during a specified grace period;
receiving information from the helper device in response to the graceful restart request if the helper device supports the graceful restart operation; and
terminating the graceful restart operation.

2. The method of claim 1, wherein:
the helper device comprises a base station if the graceful restart operation is performed for an R6 interface.

3. The method of claim 1, wherein:
the helper device comprises another gateway if the graceful restart operation is performed for an R4 interface.

4. The method of claim 1, wherein:
the helper device is operable to cease a new activity control function in response to receiving the graceful restart request.

5. The method of claim 1, further comprising:
resuming normal operation if the helper device fails to support the graceful restart operation.

6. A gateway of an access service network, the gateway operable to facilitate a graceful restart operation, comprising:
an interface operable to send and receive a plurality of packets; and
a processor coupled to the interface and operable to:
initiate a graceful restart operation;
send a graceful restart request through the interface to a helper device, the graceful restart request requesting that the helper device recognize the gateway as adjacent during a specified grace period;
receive through the interface information from the helper device in response to the graceful restart request if the helper device supports the graceful restart operation; and
terminate the graceful restart operation.

7. The gateway of claim 6, wherein:
the helper device comprises a base station if the graceful restart operation is performed for an R6 interface.

8. The gateway of claim 6, wherein:
the helper device comprises another gateway if the graceful restart operation is performed for an R4 interface.

9. The gateway of claim 6, wherein:
the helper device is operable to cease a new activity control function in response to receiving the graceful restart request.

10. The gateway of claim 6, the processor further operable to:
resume normal operation if the helper device fails to support the graceful restart operation.

11. The gateway of claim 6, wherein:
the helper device comprises:
a base station if the graceful restart operation is performed for an R6 interface; and
another gateway if the graceful restart operation is performed for an R4 interface;
the helper device is operable to cease a new activity control function in response to receiving the graceful restart request; and
the processor is further operable to:
resume normal operation if the helper device fails to support the graceful restart operation.

12. A system for facilitating a graceful restart operation, comprising:
means for initiating a graceful restart operation at a gateway of an access service network;
means for sending a graceful restart request to a helper device, the graceful restart request requesting that the helper device recognize the gateway as adjacent during a specified grace period;
means for receiving information from the helper device in response to the graceful restart request if the helper device supports the graceful restart operation; and
means for terminating the graceful restart operation.

13. A method for facilitating a graceful restart operation, comprising:
initiating a graceful restart operation at a gateway of an access service network;
sending a graceful restart request to a helper device, the graceful restart request requesting that the helper device recognize the gateway as adjacent during a specified grace period;
receiving the graceful restart request at the helper device;
sending information from the helper device to the gateway in response to the graceful restart request if the helper device supports the graceful restart operation; and
terminating the graceful restart operation.

14. The method of claim 13, wherein:
the helper device comprises a base station if the graceful restart operation is performed for an R6 interface.

15. The method of claim 13, wherein:
the helper device comprises another gateway if the graceful restart operation is performed for an R4 interface.

16. The method of claim 13, further comprising:
ceasing a new activity control function at the helper device in response to receiving the graceful restart request.

17. The method of claim 13, further comprising:
resuming normal operation if the helper device fails to support the graceful restart operation.

18. A system for facilitating a graceful restart operation, comprising:
a gateway of an access service network, the gateway operable to:
initiate a graceful restart operation; and
send a graceful restart request, the graceful restart request requesting that the gateway be recognized as adjacent during a specified grace period; and
a helper device operable to:
receive the graceful restart request; and
send information to the gateway in response to the graceful restart request if the helper device supports the graceful restart operation; and
the gateway further operable to:
terminate the graceful restart operation.

19. The system of claim 18, wherein:
the helper device comprises a base station if the graceful restart operation is performed for an R6 interface.

20. The system of claim 18, wherein:
the helper device comprises another gateway if the graceful restart operation is performed for an R4 interface.

21. The system of claim 18, the helper device further operable to:
cease a new activity control function in response to receiving the graceful restart request.

22. The system of claim 18, the gateway further operable to:
resume normal operation if the helper device fails to support the graceful restart operation.

23. The system of claim 18, wherein:
the helper device comprises:
a base station if the graceful restart operation is performed for an R6 interface; and
another gateway if the graceful restart operation is performed for an R4 interface;
the helper device is further operable to:
cease a new activity control function in response to receiving the graceful restart request; and
the gateway is further operable to:
resume normal operation if the helper device fails to support the graceful restart operation.

24. A system for facilitating a graceful restart operation, comprising:
means for initiating a graceful restart operation at a gateway of an access service network;
means for sending a graceful restart request to a helper device, the graceful restart request requesting that the helper device recognize the gateway as adjacent during a specified grace period;
means for receiving the graceful restart request at the helper device;
means for sending information from the helper device to the gateway in response to the graceful restart request if the helper device supports the graceful restart operation; and
means for terminating the graceful restart operation.
